(19) United States
(12) Patent Application Publication
(10) Pub. No.: US 2017/0355302 A1
(43) Pub. Date: Dec. 14, 2017

(54) DISPLAY APPARATUS AND MANUFACTURING METHOD THEREOF

(71) Applicant: TOYODA GOSEI CO.. LTD., Kiyosu-shi (JP)

(72) Inventors: Yuki KURAMITSU, Kiyosu-shi (JP); Hirotaka FUKUI, Kiyosu-shi (JP); Yoshiharu TANAKA, Kiyosu-shi (JP)

(21) Appl. No.: 15/618,018

(22) Filed: Jun. 8, 2017

(30) Foreign Application Priority Data
Jun. 13, 2016 (JP) 2016-117256

(51) Int. Cl. B60Q 1/50; B60R 13/00; G09F 21/04; F21V 8/00

(52) U.S. Cl. CPC B60Q 1/50; G02B 6/002; G02B 6/0031; B60R 13/005; G09F 21/04; G02B 6/0036

(57) ABSTRACT

A manufacturing method of a display apparatus including a light blocking housing having a peripheral wall and formed at an inner side of the peripheral wall with a concave part, a light source arranged in the concave part, and a lid having an opposite surface to the housing, sealing the light source in the concave part, and having a light transmitting decorative surface formed at a part of the opposite surface except for an end portion, the manufacturing method includes: forming a top surface of the peripheral wall as a stepwise surface including an outer bonding surface and an inner stepped surface lowered more than the bonding surface by one step; and bonding the end portion of the opposite surface to the bonding surface in a state in which an end portion of the decorative surface is allowed to face the stepped surface.

### CROSS-REFERENCE TO RELATED APPLICATION(S)

This application is based upon and claims the benefit of priority from Japanese Patent Application No. 2016-117256, filed on Jun. 13, 2016, the entire contents of which are incorporated herein by reference.

### BACKGROUND

### 1. Field of the Invention

The present disclosure relates to a display apparatus of a light emitting emblem and the like and a manufacturing method thereof.

### 2. Description of the Related Art

There have been proposed a plurality of technologies aiming at preventing light leakage from an unintended part of a light emitting apparatus of a lighting device for vehicles and the like. For example, JP-UM-A-H06-19201 discloses a configuration in which a housing is provided with a step overlapping a gap between an end surface of an inner lens and an inner surface of the housing as a means for preventing light from a light source from being leaked from the gap.

JP-A-2004-31114 discloses a configuration in which a step protruding toward an outer periphery is formed on an inner peripheral surface of a housing, a shading rib with a predetermined height is integrally formed at the edge of an inner periphery of the step, and a labyrinth is formed by the shading rib in the state in which the edge of a periphery of an inner lens has been fitted and mounted in a fitting mounting space formed between the shading rib and a front inner peripheral surface extending frontward from the edge of an outer periphery of the step, so that light from a light source is prevented from being leaked from a gap between the end surface of the edge of the periphery of the inner lens and the step closely facing the end surface.

As a display apparatus using a light source of a light emitting emblem and the like as a backlight, there is a display apparatus using a decoration body having a decorative surface subjected to decoration by printing and the like at the side of the light source. Even in such a display apparatus, there is a problem similar to the above that light from the light source is leaked from a gap between an inner surface of a housing and an end surface of the decoration body. When the technology disclosed in JP-UM-A-H06-19201 or JP-A-2004-31114 is applied to such a display apparatus, it is probable that the decorative surface will be damaged because the decorative surface abuts on the step or the shading rib, decoration print is peeled off, and the like. Therefore, it is probable that a design property of the display apparatus will be deteriorated because the light from the light source is leaked from a damaged part of the decorative surface.

### SUMMARY

The present invention has been made to solve the above-described problem, and an object of the present invention is to provide a display apparatus, such as a light emitting emblem provided with a decoration body having a decorative surface, capable of preventing damage of the decorative surface and effectively preventing unintended light leakage, and another object of the present invention is to provide a manufacturing method of the display apparatus.

Inventors of the present invention have arrived at the following each aspect of the present invention as a result of intensive study for solving the aforementioned problem.

According to a first aspect of the present invention, there is provided a manufacturing method of a display apparatus including a light blocking housing having a peripheral wall and formed at an inner side of the peripheral wall with a concave part, a light source arranged in the concave part, and a lid having an opposite surface to the housing, sealing the light source in the concave part, and having a light transmitting decorative surface formed at a part of the opposite surface except for an end portion, the manufacturing method including: forming a top surface of the peripheral wall as a stepwise surface including an outer bonding surface and an inner stepped surface lowered more than the bonding surface by one step; and bonding the end portion of the opposite surface to the bonding surface in a state in which an end portion of the decorative surface is allowed to face the stepped surface.

According to the manufacturing method of the aforementioned aspect, since a top surface of the peripheral wall of the housing is formed as a stepwise surface including an outer bonding surface and an inner stepped surface lowered more than the bonding surface by one step and the end portion of the opposite surface of the lid is bonded to the bonding surface in the state in which an end portion of the decorative surface is allowed to face the stepped surface, the decorative surface does not contact with the stepped surface. Thus, it is possible to prevent damage of the decorative surface due to contact of the decorative surface to the housing, thereby obtaining an effect that a decoration effect is held.

According to the manufacturing method of the present invention, the method further includes forming the decorative surface such that light from the light source is not incident into the end portion of the lid without passing through the decorative surface. Thereby, it is possible to prevent light from the light source from being leaked to an exterior of the display apparatus without passing through the decorative surface.

According to the manufacturing method of the present invention, the method further includes forming a depth of the stepped surface from the bonding surface to be larger than a thickness of the decorative surface such that the decorative surface does not abut on the stepped surface. Thus, it is possible to reliably prevent damage of the decorative surface due to contact of the decorative surface and the stepped surface.

According to the manufacturing method of the present invention, the method further includes: forming the housing and the lid with thermoplastic resin; and boding the end portion of the opposite surface of the lid and the bonding surface of the peripheral wall of the housing to each other by welding. According to such a configuration, it is possible to easily bond the end portion of the opposite surface of the lid to the bonding surface of the peripheral wall of the housing.

According to the manufacturing method of the present invention, the end portion of the opposite surface of the lid and the bonding surface of the peripheral wall of the housing are bonded to each other by ultrasonic welding or laser welding. Thus, it is advantageous that the influence of heating is prevented from affecting entire thermoplastic resin and thus discoloration and deformation of the housing and the lid due to heat are prevented.

According to the manufacturing method of the present invention, the method further includes providing the opposite surface of the lid with a protrusion thinner than the thickness of the decorative surface, before the end portion of the opposite surface of the lid and the bonding surface of the peripheral wall of the housing are bonded to each other, wherein the end portion of the opposite surface of the lid and the bonding surface of the peripheral wall of the housing are bonded to each other through the protrusion. Thus, when the decorative surface is formed by printing, the protrusion for bonding does not become an obstruction.

According to a second aspect of the present invention, there is provided a display apparatus including: a light blocking housing having a peripheral wall and formed at an inner side of the peripheral wall with a concave part; a light source arranged in the concave part; and a lid having an opposite surface to the housing, sealing the light source in the concave part, and having a light transmitting decorative surface formed at a part of the opposite surface except for an end portion, wherein: a top surface of the peripheral wall is a stepwise surface including an outer bonding surface and an inner stepped surface lowered more than the bonding surface by one step; and the end portion of the opposite surface is bonded to the bonding surface such that an end portion of the decorative surface faces the stepped surface According to the display apparatus having such a configuration, it is possible to achieve effects similar to those of the first aspect.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a front view of a light emitting emblem according to one embodiment of the present invention;

FIG. 2 is an exploded perspective view of the light emitting emblem of FIG. 1:

FIG. 3 is a sectional view taken along one-dot chain line III-III of the light emitting emblem of FIG. 1;

FIG. 4 is a sectional view illustrating main elements of the light emitting emblem of FIG. 1;

FIG. 5 is a front view of a housing of the light emitting emblem of FIG. 1;

FIG. 6 is a front view of a board of the light emitting emblem of FIG. 1;

FIGS. 7A and 7B are views illustrating a light guide plate of the light emitting emblem of FIG. 11, wherein FIG. 7A is a front view and FIG. 7B is a rear view;

FIG. 8 is a view for explaining a part of a manufacturing method of the light emitting emblem of FIG. 1;

FIG. 9 is a sectional view illustrating main elements of a light emitting emblem according to a modification example of the embodiment;

FIG. 10 is a rear view illustrating a light guide plate of the light emitting emblem according to the modification example; and

FIG. 11 is a sectional view illustrating main elements of a light emitting emblem according to a comparative example of the present invention.

### DETAILED DESCRIPTION OF THE INVENTION

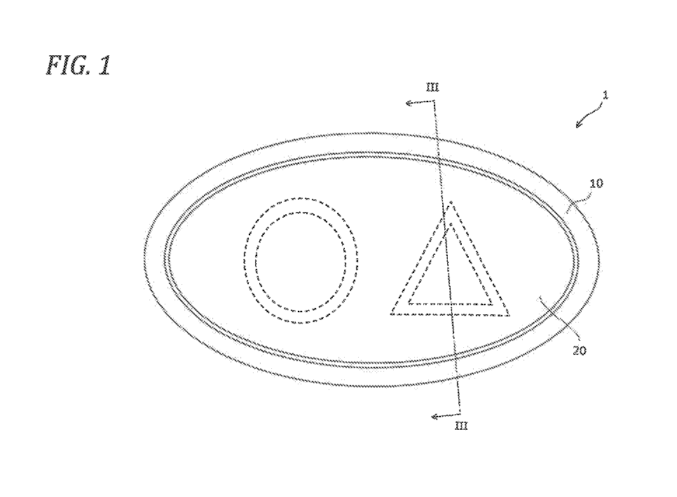

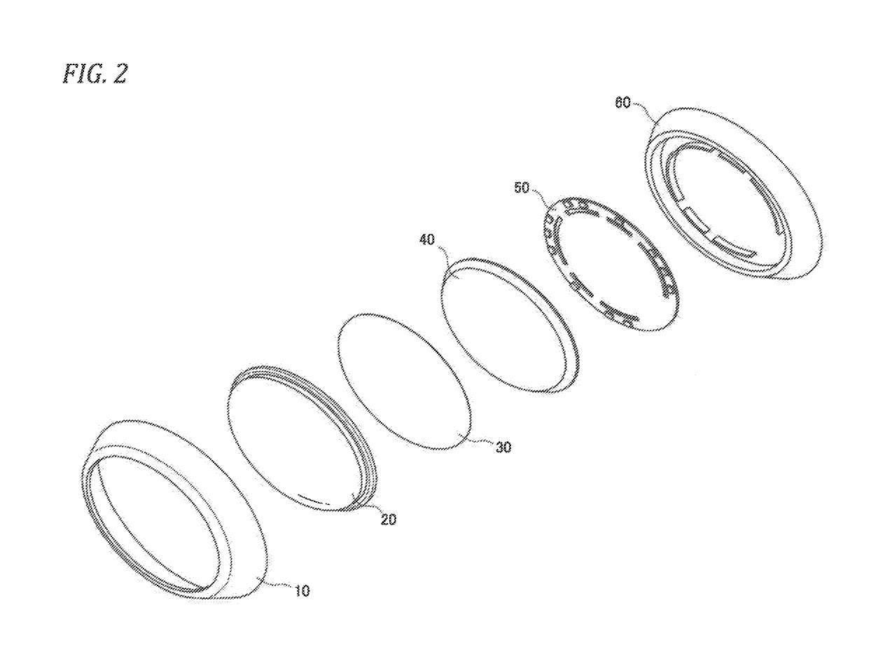

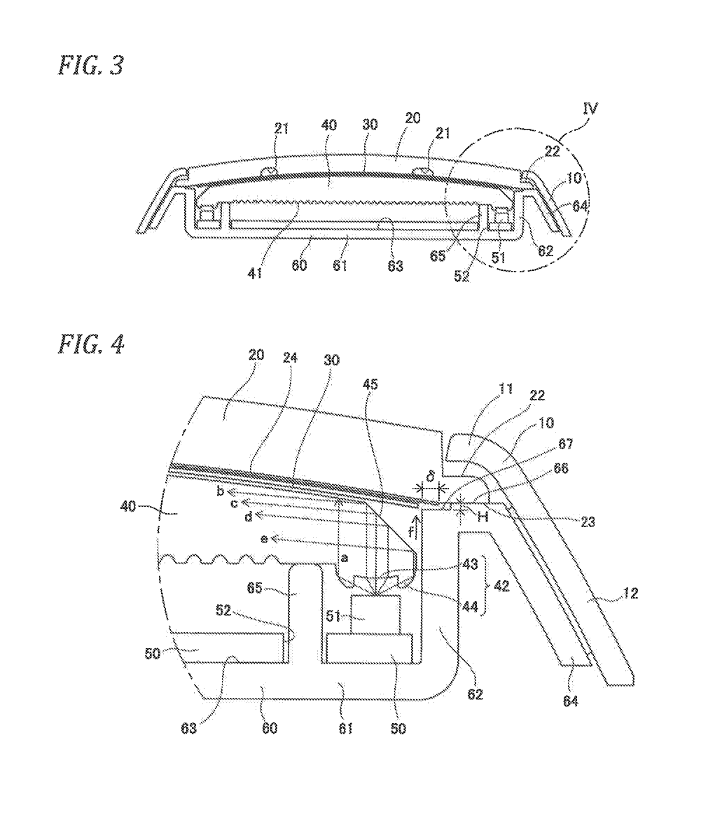

Hereinafter, a light emitting emblem 1 as an example of a display apparatus according to one embodiment of the present invention will be described with reference to the accompanying drawings. FIG. 1 is a front view of the light emitting emblem 1 according to the embodiment, and the light emitting emblem 1 of the present example is mounted in a vehicle such as an automobile to display a name and a logo mark of a maker, a vehicle name, a grade and the like (hereinafter, these are generically referred to as a “mark”). FIG. 1 schematically illustrates marks by a circle and a triangle indicated by broken lines. FIG. 2 is an exploded perspective view of the light emitting emblem 1 and FIG. 3 is a sectional view taken along one-dot chain line III-III of the light emitting emblem 1 of FIG. 1. As illustrated in these drawings, the light emitting emblem 1 of the present example is obtained by overlappingly combining a frame body 10, an ornament 20 (a decoration body or a lid), a sheet 30, a light guide plate 40, a board 50, and a housing 60 with one another, and its entire shape is approximately flat. In FIG. 2, the marks are not illustrated. The housing 60, for example, is mounted in a radiator grille of a vehicle. A mounting structure of a screw, a screw hole and the like for mounting the light emitting emblem 1 in a vehicle, and a structure for receiving power from a vehicle are not illustrated. The outer peripheral shape of the illustrated light emitting emblem 1 is an oval shape; however, this is an illustrative purpose only and the present invention is not limited thereto.

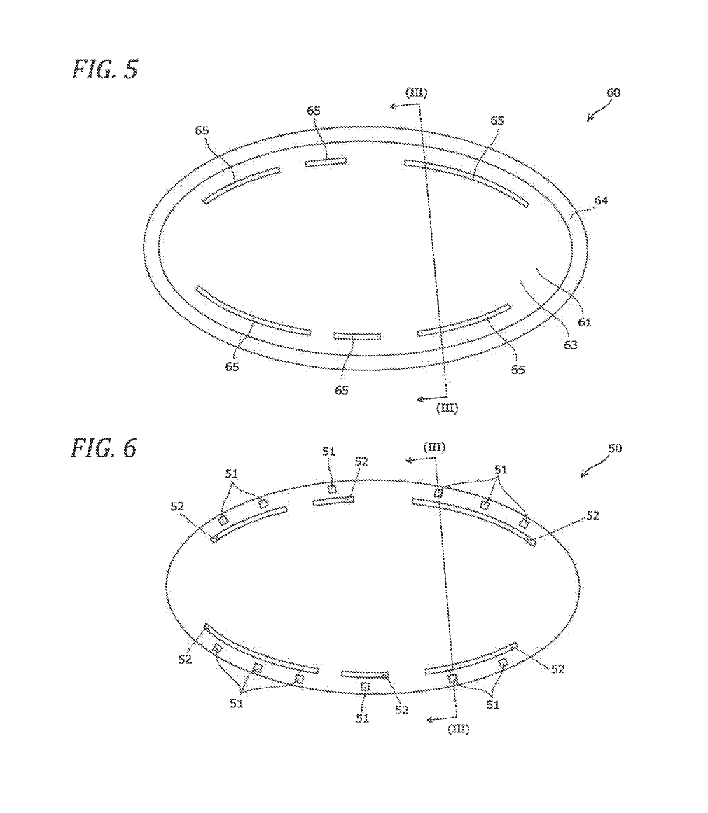

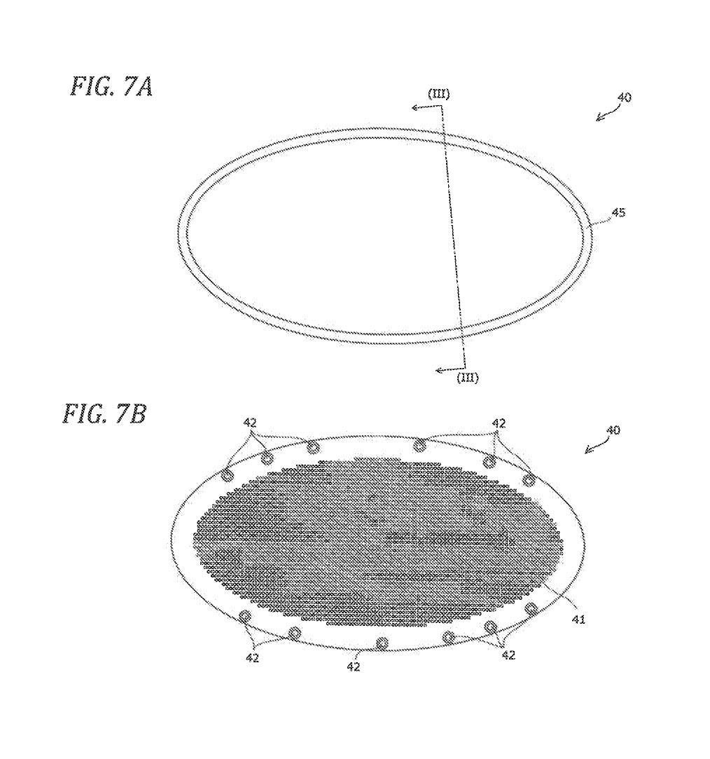

FIG. 5 is a front view of the housing 60. The housing 60 is made of non-translucent synthetic resin (for example, AES resin, ABS resin, ASA resin, PC resin and the like), and has a bottom surface part 61 serving as a mounting surface to a vehicle and a wall part 62 (or a peripheral wall) vertically installed at the peripheral edge thereof as illustrated in FIGS. 3 and 5, wherein a concave part 63 is defined by the bottom surface part 61 and the wall part 62. A surface (an upper surface in FIGS. 3 and 4 and hereinafter, referred to as a “top surface”) of a tip end opposite to the bottom surface part 61 of the wall part 62 is formed as a stepwise surface including an outer bonding surface 66 and an inner stepped surface 67 lowered more than the bonding surface 66 by one step. A frame body mounting part 64 is formed in eaves shape inclined in a mounting direction (a downward direction in FIG. 3 and hereinafter, referred to as a “mounting direction”) to a vehicle and in an outward direction from an outer part of an end portion of the top surface of the wall part 62. At a surface (an upper surface in FIG. 3) opposite to the mounting direction of the bottom surface part 61, a plurality of (six in the illustrated example) shielding plates 65 are vertically installed to extend along the wall part 62 in the vicinity of the wall part 62. One-dot chain line (III)-(III) of FIG. 5 indicates a position through which one-dot chain line III-III of FIG. 1 passes (the same is also in FIGS. 6 and 7A).

FIG. 6 is a front view of the board 50. The board 50 is a wiring board provided on the surface thereof with a wiring, such as a glass epoxy board and a flexible board. The wiring on the board 50 is not illustrated. An outer peripheral shape of the board 50 is a shape following the inner peripheral shape of the wall part 62 of the housing 60, so that the board 50 is received in the concave part 63 of the housing 60 and is installed on the bottom surface part 61. In the vicinity of a peripheral edge of the board 50, a plurality of (12 in the illustrated example) LEDs 51 are distributed and mounted at predetermined positions along a circumferential direction of the board 50. In the board 50, a plurality of (6 in the illustrated example) through holes 52 (slits) are formed inside the places, where the LEDs 51 are arranged, in proximity to the LEDs 51 so as to extend along the circumferential direction. One through hole 52 is formed for one LED 51 or a plurality of LEDs 51. Each through hole 52 is formed to cross a line segment linking a corresponding LED 51 to a central vicinity of the board 50. These plurality of through holes 52 are formed to have positions and shapes corresponding to the plurality of shielding plates 65 of the housing 60. Therefore, when the board 50 is installed in the concave part 63 of the housing 60, the shielding plates 65 of the housing 60 can be respectively inserted into corresponding through holes 52 of the board 50. Thus, there is an effect that positioning of the board 50 with respect to the housing 60 is achieved.

FIGS. 7A and 7B are views illustrating the light guide plate 40 of the light emitting emblem of FIG. 1, wherein FIG. 7A is a front view and FIG. 7B is a rear view. The light guide plate 40 is a member made of transparent resin (for example, acryl resin, PC resin and the like) and having an overall flat shape. The light guide plate 40 has an outer peripheral shape following the inner periphery of the wall part 62 of the housing 60 and is received in the concave part 63 of the housing 60. In this case, a surface (hereinafter, referred to as a “rear surface”) of the light guide plate 40, which faces the board 50, abuts on the tip ends of the plurality of shielding plates 65 of the housing 60, which protrude from the plurality of through holes 52 of the board 50, so that the surface is supported. A large number of fine concave parts 41 are formed at a part of the rear surface of the light guide plate 40, which excludes the part abutting on at least the shielding plates 65 and includes the central vicinity of the light guide plate 40. Light entering parts 42 corresponding to the respective LEDs 51 are protrudingly provided at parts of the rear surface of the light guide plate 40, which face the plurality of LEDs 51. As illustrated in FIG. 4 obtained by enlarging the range surrounded by one-dot chain line IV of FIGS. 3 and 7B, each light entering part 42 has a central convex portion 43 and a reflection portion 44 protrudingly provided around the central convex portion 43 in a circular shape. An inclination part 45 is formed at a peripheral edge of a surface (hereinafter, referred to as a “front surface”) opposite to the LED 51 of the light guide plate 40, and is inclined to be proximate to the board 50 side toward the outer peripheral side of the light guide plate 40.

Referring to FIG. 3, the sheet 30 is made of transparent synthetic resin (for example, PC resin, PMMA resin, PET resin and the like) and is subjected to various types of decoration processing (for example, coloring treatment, half-mirror treatment, pattern printing and the like). The sheet 30 is arranged on the front surface of the light guide plate 40.

The ornament 20 is provided on a surface thereof serving as a rear surface after assembling, that is, a surface (a lower surface in FIGS. 3 and 4 and hereinafter, referred to as an “opposite surface”) serving as an opposite side of the housing 60 with engraved parts 21 having a mark shape. At a peripheral edge (an end portion) of a surface (a front surface) opposite to the opposite surface of the ornament 20, a stepped part 22 is formed. A peripheral edge 23 (hereinafter, also referred to as an “end portion”) of the opposite surface of the ornament 20 is bonded to a bonding surface 66 of the wall part 62 of the housing 60. The ornament 20 and the housing 60 are bonded to each other, so that a box shape is achieved. Since the light emitting emblem 1 is mainly used as an exterior product, the bonding part of the ornament 20 and the housing 60 needs to have a water stop function. As the bonding method, welding (fusion) such as ultrasonic welding or laser welding, adhesion by a hot melt or an adhesive, and the like can be exemplified. Preferably, the ornament 20 and the housing 60 are respectively made of thermoplastic resin and ultrasonic welding or laser welding is used to bond them to each other. By so doing, the influence of heating can be prevented from affecting the entire thermoplastic resin, so that it is possible to prevent discoloration and deformation of the ornament 20 and the housing 60 due to heat. A part of the opposite surface of the ornament 20, except for the end portion 23, is subjected to various types of decoration processing (for example, coloring treatment, half-mirror treatment, pattern printing and the like). In the example of FIG. 4, a light transmitting decorative layer 24 (a decorative surface) is formed on the opposite surface of the ornament 20, except for the end portion 23, by printing. The sheet 30 is interposed between the ornament 20 and the light guide plate 40.

As described above, as illustrated in FIG. 4, in the configuration in which the end portion 23 of the opposite surface of the ornament 20 is bonded to the bonding surface 66 of the housing 60, the stepped surface 67 of the housing 60 is lowered more than the bonding surface 66 by one step. In FIG. 4, the depth, by which the stepped surface 67 is lowered more than the bonding surface 66, is indicated by a sign H. A space is formed between the opposite surface of the ornament 20 and the stepped surface 67 of the housing, so that the end portion of the decorative layer 24 is inserted into the space (in the section illustrated in FIG. 4, the end portion of the decorative layer 24 is inserted by a width δ). Since such insertion of the decorative layer 24 is enabled and a contact between the decorative layer 24 and the stepped surface 67 is prevented, the depth H of the stepped surface 67 from the bonding surface 66 is set to be larger than the thickness of the decorative layer 24.

By changing the degree of transmission of decoration of a part in a range of a predetermined width (for example, 10 mm) from the peripheral edge of the decorative layer 24 of the ornament 20, particularly, a part overlapping the LED 51 and the vicinity thereof (for example, lowering transmittance or increasing opaqueness), the LED 51 may be concealed from an exterior. The same may be performed with respect to a part in a predetermined width from the end portion of the sheet 30.

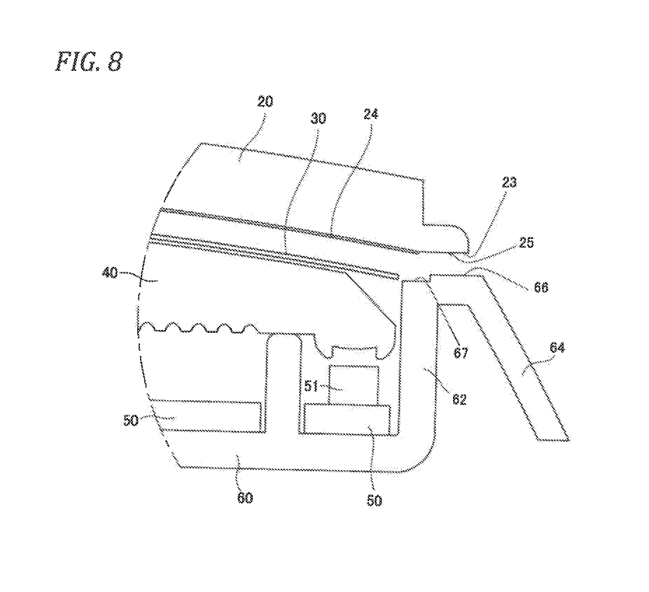

FIG. 8 is a view illustrating a part of a manufacturing process of the light emitting emblem 1 according to the present embodiment, and is a detailed sectional view of main elements illustrating the state before the end portion 23 of the opposite surface of the ornament 20 is bonded to the bonding surface 66 of the housing 60 by ultrasonic welding or laser welding. In the state before the bonding, since a rib-like protrusion 25 with a narrow width is formed at the end portion 23 of the opposite surface of the ornament 20, the bonding by welding is performed through the protrusion 25. Thus, it is possible to easily perform the welding with high precision. Preferably, the height of the protrusion 25 is lower than the thickness of the decorative layer 24. This is for preventing the protrusion 25 from becoming an obstruction when the decorative layer 24 is formed by printing.

The entire shape of the frame body 10 is a circular shape, and more specifically, the frame body 10 includes a circular part 11 on the inner peripheral side, which overlaps the stepped part 22 of the ornament 20, and a cover part 12 extending in an inclination shape outward from the circular part 11. The cover part 12 has a shape following the frame body mounting part 64 of the housing 60, and at the time of assembling, the cover part 12 and the frame body mounting part 64 adhere to each other by a double-sided tape and the like. Alternatively, the cover part 12 may be formed in a cylindrical shape without forming the frame body mounting part 64, and its inner peripheral surface may adhere to the outer peripheral surface of the wall part 62 of the housing 60.

(Description of Functions of Light Emitting Emblem 1)

Next, the functions of the light emitting emblem 1 after assembling completion will be described with reference to mainly FIGS. 3 and 4. An optical axis of the LED 51 is directed to the light entering part 42 side of the light guide plate 40. Light emitted from the LED 51 after activation of the LED 51 enters into the light guide plate 40 through the light entering part 42. More specifically, the LED 51 is arranged at a focal point of the convex portion 43 of the light entering part 42, and as exemplified by the arrows b, c, and d in FIG. 4, the light incident into the convex portion 43 becomes an approximate parallel light in the light guide plate 40.

The inner peripheral surface of the reflection portion 44 of the light entering part 42 serves as a light incidence surface and the outer peripheral surface thereof serves as a reflection surface. As exemplified by the arrows a and e in FIG. 4, the light incident into the incidence surface of the reflection portion 44 is reflected (or is totally reflected) by the reflection surface, so that the light becomes an approximate parallel light in the light guide plate 40 with respect to the light incident into the convex portion 43.

As exemplified by the arrows b, c, d and e in FIG. 4, a part of the light entered into the light guide plate 40 through the light entering part 42 is reflected (or is totally reflected) in a horizontal direction with respect to the optical axis by the inclination part 45 serving as a reflection surface. In order to enable the reflection (or the total reflection) by the inclination part 45, for example, the inclination part 45 is formed to have an inclination angle of about 45° with respect to the optical axis of the LED 51. In this way, light toward the inner side portion (that is, a part including the central vicinity except for the peripheral edge) of the light guide plate 40 is sent to the outside from the front surface of the light guide plate 40, or is reflected by the large number of fine concave parts 41 formed at the rear surface and then is sent to the outside from the front surface of the light guide plate 40, and is emitted to an exterior from the front surface of the light emitting emblem 1 by passing through the sheet 30 and the ornament 20.

As exemplified by the arrow a in FIG. 4, a part of the light entered into the light guide plate 40 from the light entering part 42 is sent to the outside from the front surface of the light guide plate 40 without abutting on the inclination part 45. As described above, in the case of changing the degree of transmission of the decoration of the vicinity of the peripheral edge of at least one of the ornament 20 and the sheet 30, particularly, the part overlapping the LED 51 and the vicinity part thereof, the light is suppressed from being leaked to an exterior of the light emitting emblem 1.

As described above, as illustrated in FIGS. 3 and 4, the shielding plate 65 of the housing 60 is inserted into the through hole 52 of the board 50. By so doing, the shielding plate 65 is arranged in the vicinity of the LED 51 and inside (the side near the center) the light emitting emblem 1 from the LED 51. By so doing, the LED 51 is prevented from being visually recognized through the light transmitting part around the center of the ornament 20 and the sheet 30 from the outside of the light emitting emblem 1. Each shielding plate 65 extends to cross a direction toward the center of the light emitting emblem 1 from the LED 51. Thus, it is possible to enhance the visual recognition prevention effect of the LED 51.

As described above, FIG. 4 illustrates the structure in which the end portion of the decorative layer 24 of the ornament 20 is inserted by the width δ into the space formed between the opposite surface of the ornament 20 and the stepped surface 67 of the housing. Therefore, as exemplified by the arrow f in FIG. 4, when the light, which is emitted by the LED 51, is reflected in the concave part 63 or passes through the light guide plate 40, and has the luminescent color of the LED 51, reaches the vicinity of a corner formed by the inner surface of the wall part 62 of the housing 60 and the opposite surface of the ornament 20, the light abuts on the decorative layer 24 and is not leaked to an exterior through between the bonding part of the ornament 20 and the housing 60 and the end portion of the decorative layer 24. That is, the light having the luminescent color of the LED 51 is not leaked to an exterior without passing through the decorative layer 24. This is guaranteed by the structure in which the end portion of the decorative layer 24 faces the stepped surface 67 by the predetermined width δ.

By so doing, the light, which is emitted by the LED 51, is reflected in the concave part 63 or passes through the light guide plate 40, and reaches the vicinity of the aforementioned corner with the luminescent color of the LED 51, should be subjected to color conversion by the decorative layer 24 before being sent to an exterior of the light emitting emblem 1. Thus, in this case, light subjected to the color conversion by the decorative layer 24 and light subjected to no conversion and having the luminescent color of the LED 51 can be prevented from being mixed with each other.

On the other hand, when the vicinity of the end portion of the decorative layer 24 is actually opaque in order to conceal the LED 51, the light, which is emitted by the LED 51, is reflected in the concave part 63 or passes through the light guide plate 40, and reaches the vicinity of the aforementioned corner with the luminescent color of the LED 51, is blocked by the decorative layer 24 and is not leaked to an exterior of the light emitting emblem 1. Thus, it is possible to prevent light leakage from an unintended part.

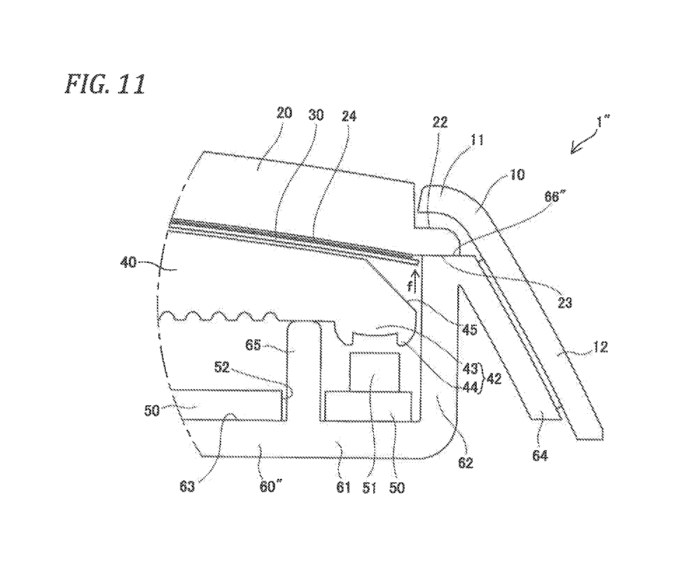

In order to more distinctly explain the effects according to the present embodiment, FIG. 11 illustrates a sectional view of main elements of a light emitting emblem 1″ having a configuration in which an entire top surface of a housing 60″ is employed as a bonding surface 66″ and no stepped surface is provided, as a comparative example. In order not to form a gap between a bonding part of the ornament 20 and the housing 60″ and the end portion of the decorative layer 24, when the decorative layer 24 is allowed to extend to a position facing the bonding surface 66″ of the housing 60″, since bonding strength of the ornament 20 and the housing 60″ is reduced at a part at which the decorative layer 24 and the bonding surface 66″ faces each other, it is probable that a sufficient water stop effect cannot be obtained. Therefore, as illustrated in FIG. 11, the end portion of the decorative layer 24 needs to be held at the concave part 63 side of the housing 60″. As a consequence, since a slight and non-decorative gap is formed between the bonding part of the end portion 23 of the opposite surface and the bonding surface 66″ of the housing 60″ and the end portion of the decorative layer 24, it is probable that light (that is, light not passing through the decorative layer 24), which is emitted from the LED 51 and has the luminescent color of the LED 51, is leaked to an exterior of the light emitting emblem 1 and a design property is deteriorated. This is particularly considerable in a configuration in which the LED 51 serving as a light source is arranged in the vicinity of the inner surface of the concave part 63 of the housing 60″.

In order to allow the end portion of the decorative layer 24 to face the stepped surface 67 as illustrated in FIG. 4 without changing the range of the decorative layer 24 illustrated in FIG. 11, the stepped surface 67 is provided and the wall part 62 is allowed to be displaced inward (the left side in FIG. 11) in the example of the housing 60″ of FIG. 11, so that it is achievable. By so doing, it is possible to achieve the configuration of the present embodiment without causing a change in design when the decorative layer 24 is viewed from the front surface.

### Modification Example

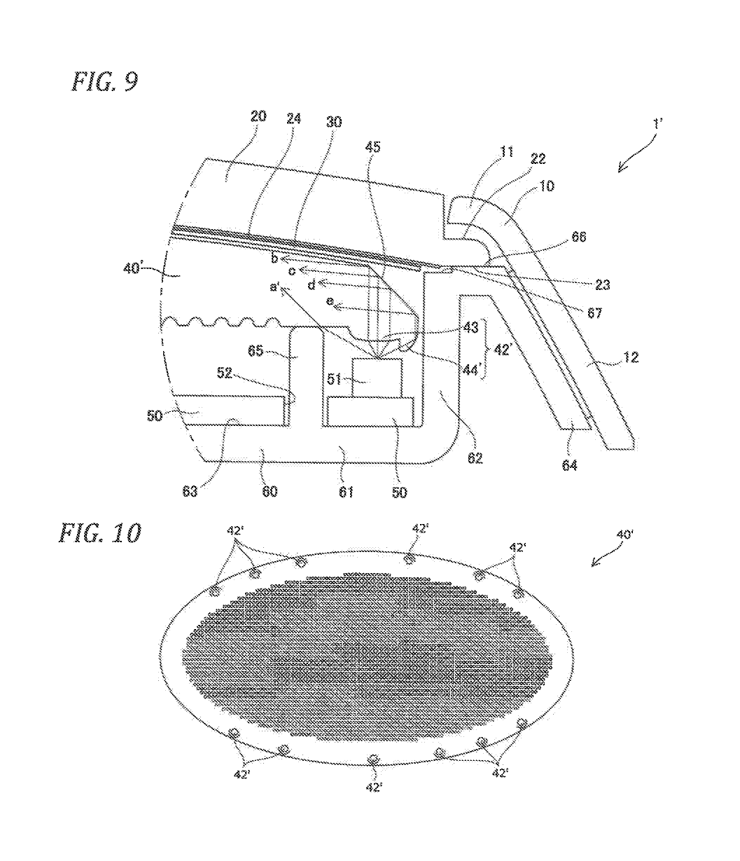

FIG. 9 is a sectional view illustrating main elements of a light emitting emblem 1′ according to a modification example of the embodiment, and FIG. 10 is a rear view illustrating a light guide plate 40′ of the light emitting emblem 1′. FIG. 9 is a view replacing FIG. 4 of the embodiment. As illustrated in FIGS. 9 and 10, in the light guide plate 40′ of the modification example, the shape of a light entering part 42′ is different from that of the light entering part 42 of the embodiment. More specifically, in the modification example, a reflection portion 44′ is provided only at a position serving as an outer peripheral side of the light guide plate 40′ from the center of the convex portion 43 of the light entering part 42′, and is not provided at a position serving as the center side of the light guide plate 40′. Thereby, as exemplified by the arrow a′ in FIG. 9, light incident into the light guide plate 40′ inward from the convex portion 43 can also be used for light emission of the light emitting emblem 1′.

The present invention is not limited to the description of the aforementioned aspect, the aforementioned embodiment, and the aforementioned modification example. The present invention also includes various modification examples in the range, which can be easily achieved by a person skilled in the art, without departing from the scope of claims. The entire content of gazettes and the like in the present specification is incorporated by reference.

What is claimed is:

1. A manufacturing method of a display apparatus including a light blocking housing having a peripheral wall and formed at an inner side of the peripheral wall with a concave part, a light source arranged in the concave part, and a lid having an opposite surface to the housing, sealing the light source in the concave part, and having a light transmitting decorative surface formed at a part of the opposite surface except for an end portion, the manufacturing method comprising:
forming a top surface of the peripheral wall as a stepwise surface including an outer bonding surface and an inner stepped surface lowered more than the bonding surface by one step; and
bonding the end portion of the opposite surface to the bonding surface in a state in which an end portion of the decorative surface is allowed to face the stepped surface.

2. The manufacturing method of the display apparatus according to claim 1, further comprising:
forming the decorative surface such that light from the light source is not incident into an end portion of the lid without passing through the decorative surface.

3. The manufacturing method of the display apparatus according to claim 1, further comprising:
forming a depth of the stepped surface from the bonding surface to be larger than a thickness of the decorative surface such that the decorative surface does not abut on the stepped surface.

4. The manufacturing method of the display apparatus according to claim 1, further comprising:
forming the housing and the lid with thermoplastic resin; and
boding the end portion of the opposite surface of the lid and the bonding surface of the peripheral wall of the housing to each other by welding.

5. The manufacturing method of the display apparatus according to claim 4, wherein
the end portion of the opposite surface of the lid and the bonding surface of the peripheral wall of the housing are bonded to each other by ultrasonic welding or laser welding.

6. The manufacturing method of the display apparatus according to claim 1, further comprising:
providing the opposite surface of the lid with a protrusion thinner than the thickness of the decorative surface, before the end portion of the opposite surface of the lid and the bonding surface of the peripheral wall of the housing are bonded to each other, wherein
the end portion of the opposite surface of the lid and the bonding surface of the peripheral wall of the housing are bonded to each other through the protrusion.

7. A display apparatus comprising:
a light blocking housing having a peripheral wall and formed at an inner side of the peripheral wall with a concave part;
a light source arranged in the concave part; and
a lid having an opposite surface to the housing, sealing the light source in the concave part, and having a light transmitting decorative surface formed at a part of the opposite surface except for an end portion, wherein:
a top surface of the peripheral wall is a stepwise surface including an outer bonding surface and an inner stepped surface lowered more than the bonding surface by one step; and
the end portion of the opposite surface is bonded to the bonding surface such that an end portion of the decorative surface faces the stepped surface.
